(19) United States
(12) Patent Application Publication
(10) Pub. No.: US 2024/0239112 A1
(43) Pub. Date: Jul. 18, 2024

(54) SIMULATION DEVICE FOR SIMULATING THE PRINTING OF A PRINT SUBSTRATE WITH A PRINTING PATTERN, AND A CORRESPONDING METHOD

(71) Applicant: MANZ AG, Reutlingen (DE)

(72) Inventor: Martin FREUNDT, Esslingen (DE)

(21) Appl. No.: 18/558,835

(22) PCT Filed: Apr. 28, 2022
(86) PCT No.: PCT/EP2022/061346

§ 371 Date: Nov. 3, 2023

(30) Foreign Application Priority Data
May 6, 2021 (DE) 10 2021 111 846.8

(51) Int. Cl. B41J 3/407; B41J 2/045

(52) U.S. Cl. CPC B41J 3/4073; B41J 2/04526; B41J 2/04593

(57) ABSTRACT

A simulation device for simulating the printing of a printing pattern on a print medium, wherein the print medium includes at least one 3D surface portion to be printed on, with: a printhead specification module for specifying printhead parameters; an object specification module for specifying object parameters of the print medium; an ink specification module for specifying ink parameters of the printing ink; a pattern specification module for specifying the printing pattern; a path planning module for specifying path planning data for the print medium 1 and for the printhead; and a simulation central module for simulating the print on the 3D surface portion taking into account the printhead parameters, object parameters, ink parameters, path planning parameters and the printing pattern.

The invention relates to a simulation device for simulating the printing of a printing pattern on a print medium, having the features of claim 1. The invention further relates to a corresponding method.

Printing using printing ink is established prior art with regard to color printing methods on paper. Nowadays, inkjet printers are common alternatives to a printer with toner.

3D products, though, are printed on using printing ink technology. However, the difficulty of this is that the printheads have certain spatial dimensions such that it is possible for there to be a decrease in quality when covering the 3D product to be printed on. Typically, for this reason, before a printing process enters series production, a test rig is set up to implement the printing process so that it is possible to detect any loss of quality in the printing process and to improve the printing process by experimentation.

The object of the present invention is to propose an option for simplifying the implementation of a printing process using printing ink technology. This object is achieved by a simulation device having the features of claim 1 and by a method having the features of claim 14 and by a further simulation device having the features of claim 15. Preferred or advantageous embodiments of the invention are found in the dependent claims, the following description and the accompanying drawings.

The invention relates to a simulation device which is configured to simulate the printing of a printing pattern on a print medium. The simulation device is in particular configured as a digital data processing device. Said simulation device can be centralized or also distributed in a decentralized manner. The individual modules described in the following can each be implemented on a shared digital data processing device, but it is also possible for said modules to be distributed across different data processing devices. In particular it is also possible for the simulation device to be provided in a client/server and/or cloud service and/or Saas (Software as a Service) architecture in the cloud. The individual modules preferably represent the logic functional blocks; however, they can be configured as software and/or hardware, as desired, and/or can be distributed.

The print medium can be configured as any desired product. In particular, the print medium is implemented as a three-dimensional object. It is thus possible for the print medium to be a bottle, a skirting board, a vehicle component, a cell phone, etc. The printing pattern is configured as planar printed information, in particular color information, preferably arranged in the manner of a matrix. For example, the printing pattern can be configured as, or comprise, an image, lettering, a barcode and/or a structured functional coating, even with functional inks, such as conductive inks, active layers, etc. The print medium comprises at least one 3D surface portion to be printed on. The 3D surface portion can be configured in particular as an undulating, folded, contoured, stepped or continuously or non-continuously extending surface portion. As part of the printing process, it is provided that the printing pattern is printed on the 3D-surface portion. The printing method is configured in particular as an inkjet printing method, e.g., a DOD printing method (Drop on Demand).

The simulation device comprises a printhead specification module which is configured to specify printhead parameters. The printhead parameters can be any desired selection of relevant parameters of the printhead. For example, a printing area, a target printing distance, a number of printing lines, the length of the printing lines, the spacing of the printing lines, the number of printing nozzles and spacing of the printing nozzles or alternatively the specific positions of the nozzles in a printhead are defined, possible modes of operation and metering characteristics regarding metering behavior such as reproducibility of the propulsion parameters of the printhead, direction of flight of the droplets and satellites, discharge speed of the droplets, diameter of the printing nozzles and droplets, etc. are provided as parameters. The parameters can also be delivered to the printhead specification module as measured and/or modeled and/or parameters or parameter fields. Optionally, it is possible to store measurement data for a specific printhead in the simulation in order to take compensatory action in the system beforehand, which can be prepared offline, or also merely in order to be able to predict the expected printing quality on the basis of the measurement data from the quality monitoring of the printhead.

The simulation device comprises an object specification module for specifying object parameters of the print medium. The object parameters include, for example, the geometric structure of the 3D surface portion, the position of the 3D surface portion, the material and/or the properties, in particular the surface properties of the 3D surface portion etc., or other properties influencing the flight of the droplets, such as temperature, humidity and, e.g., electrostatic charge.

The simulation device comprises an ink specification module for specifying ink parameters of the printing ink. The ink parameters include the color of the printing ink. Said ink parameters also include, for example, the specific density, parameters regarding curing behavior, parameters regarding mixing behavior, parameters regarding surface tension, etc., particle fill level, surface tension or other physical/chemical properties that influence the flight or the interaction with the surface being printed on. In particular, the printing ink is configured as a color printing ink.

The simulation device comprises a pattern specification module for specifying the printing pattern. The printing pattern has parameters as already described above.

The printing pattern and the object parameters can be delivered separately or together (e.g., in the form of a 3D file including texture or associated UV mapping data). Alternatively, a CAD model of the object, together with the printing pattern, can be delivered, with the printing pattern and the object parameters optionally being separated in a preliminary stage, or the pattern specification module and the object specification module being combined to form a joint module.

Optionally, the simulation device comprises a curing specification module for specifying parameters regarding curing devices, such as UV lamps or IR lamps. Furthermore, parameters regarding the intensity, position of the curing devices, etc. can be specified and optionally varied.

Furthermore, the simulation device comprises a path planning module for specifying path planning data for the print medium and for the printhead. It can be provided here that the print medium is stationary and the printhead is moved, that the print medium is moved and the printhead is stationary, and/or that the print medium and the printhead are movable. Preferably, during the printing process, in particular during the transfer of the printing ink, at least the print medium is moved and/or movable. In general, in the path planning module, there are the parameters for the movement of the print medium and the printhead themselves and the relative movement data between the print medium and the printhead. The relative movement data includes in particular a relative movement, a relative position, a relative speed and/or a relative acceleration between the print medium and the printhead. In particular, the path planning module determines the relative movement data and/or the relative movement and/or the relative position and/or the relative speed and/or the relative acceleration between the print medium and the printhead. The path planning module can comprise an auxiliary module, with the auxiliary module assigning printing regions to the printheads and/or printing nozzles. In particular, the auxiliary module has a function that makes it possible to identify the overlap regions of the print images of two printheads that print from two different directions and to configure transition regions in relation to the division of the print image across two adjacent printing paths. As a further function, the auxiliary module can have a raster image processor (RIP) function. Preferably, the auxiliary module processes the raw data and breaks it down into printing portions which, depending on the configuration of the printhead system, can be configured differently:
mode in which individual paths are sequentially printed with the same printhead
paths distributed across different printheads with the same ink such that printing can be performed in “one pass”
separate from the two variants, the option of forming an overlap with the paths that “mediate” the joints.

Furthermore, the path planning module can comprise an auxiliary module for taking into account the curing devices and the parameters thereof.

If a plurality of printheads, printing inks, printing patterns, objects, etc. are to be used, there are multiple respective parameter sets that are defined on the basis of the environmental and operating conditions, as appropriate.

Within the scope of the invention, it is proposed for the simulation device to comprise a simulation central module which is configured to simulate printing on the 3D-surface portion taking into account the printhead parameters, object parameters, ink parameters, path planning data, and the printing pattern and optionally additionally environmental conditions and flow conditions, machine behavior. It is thus proposed to use the mentioned parameters or data as input data for the simulation central module and to obtain the simulated print on the 3D surface portion in model form as output data.

It is a consideration of the invention that the mentioned input parameters or data make it possible to calculate, determine or at least evaluate a printing result in the form of the 3D surface portion. In this way, instead of setting up a functional prototype for a printing system at the expense of time and money, it is possible to carry out a corresponding simulation, such that the print on the 3D surface portion can be evaluated and optionally optimized without a functional prototype. In particular, the simulation device is suitable and/or configured for evaluating and optionally optimizing the print on the 3D surface portion in order to implement a printing process which is in particular real and in which the print medium is printed on in the 3D surface portion by inkjet technology such that there is a print with printing ink on the 3D surface portion.

In particular, real parameters are measured by the production system for the real print or are determined from data sheets or the like and supplied to the simulation. The simulation can adjust these parameters within the limits of the production system. Subsequently, the parameters improved in the simulation can be transferred to the production system, which corresponds to taking compensatory action in the system. The adjustment of the parameters in the production system will result in an improved print in the production system. The parameters of the production system include parameters of the printhead as a printhead specification module, the parameters of the path planning data, the parameters for the ink as an ink specification module with an influence on the droplet auxiliary module that results in the selection of an ink with certain properties, the parameters for the printing pattern, the parameters for the environment as an environment auxiliary module, the parameters for the system as a system auxiliary module and/or parameters for curing as curing parameters.

Particularly preferably, the simulation device is suitable and/or configured such that the printing process for printing on the 3D-surface portion is simulated taking into account the printhead parameters, object parameters, ink parameters, path planning data, and the printing pattern and optionally additionally environmental conditions and flow conditions, machine behavior, with the mentioned parameters or data being used as input data for the simulation central module, and the simulated print on the 3D surface portion being obtained in model form as output data, the mentioned parameters or data being transferred to a real printing process, specifically in order to avoid and/or reduce real test prints.

The invention optionally further relates to a method in which the simulation device according to any one of claim 1 to 14 or 15 and/or the description simulates, and optionally additionally optimizes, the printing process for printing on the 3D-surface portion taking into account the printhead parameters, object parameters, ink parameters, path planning data, and the printing pattern and optionally additionally environmental conditions and flow conditions, machine behavior, and then implements the simulated printing process, in particular using the mentioned parameters or data, in a real printing process and/or on a real printing system in order to actually implement the simulated and/or optimized printing of the printing pattern on the 3D-surface portion.

The simulation device or the further simulation device is in particular configured as a digital twin to a real printing system in order to simulate the printhead parameters, object parameters, ink parameters, path planning data, and the printing pattern and optionally additionally environmental conditions and flow conditions, machine behavior, and to then implement the simulated print, in particular to transfer the mentioned parameters or data to the real printing system and to actually implement said printing in the printing process.

The simulation device or the further simulation device is in particular configured as a, or the, digital twin to a, or the, real printing system for printing the print medium on the print medium, with the print simulated by the simulation device being transferable and/or transferred to the real printing system as a real printing process.

The specification modules can—as will be explained below—determine or specify the relevant parameters or data themselves, or said specification modules each have an input interface in order to input the relevant parameters or data or to input at least initial values for these parameters or this data.

The parameters can be configured as measured parameters, interpolated parameters, evaluated parameters and corresponding parameter maps.

In a preferred embodiment, the simulation central module comprises a transfer module for determining the transfer of the printing ink from the printhead to the 3D surface portion. The transfer module calculates, determines and/or evaluates the transfer path between the discharge point on the printhead and the impact point on the 3D surface portion. The printhead parameters can be used to set the discharge point of the printing ink, for example, and the path planning data and the object parameters can be used to determine the relative position and/or relative movement and/or relative speed and/or relative acceleration between the printhead and the print medium. The ink parameters and the printing pattern can be used to determine the output color and the physical properties thereof. With these parameters and this data, the system for the transfer of printing ink from the printhead onto the print medium, in particular onto the 3D surface portion, is thus determined in a complete and deterministic manner such that the impact point on the 3D surface portion can be determined.

In a preferred embodiment of the invention, the impact point is determined together with time information. The time information can be configured as absolute time information or as relative time information. Thus, the transfer module determines not only the position of the impact point on the 3D surface portion, but also the time of the impact.

In a preferred further development of the invention, the transfer module is configured as a trajectory module. The trajectory module determines at least one trajectory, certain trajectories or all trajectories for the printing ink on the path between the printhead and the 3D surface portion. In particular a physical model of the trajectories for the printing ink is thus used and/or implemented.

If the printing ink is transferred from the printhead to the print medium in the form of droplets, it is preferred for the trajectory module to determine the at least one trajectory for each ink droplet. Preferably, the trajectory is determined for each ink droplet required to print the printing pattern on the print medium. Thus, a complete model of the print transfer using individual ink droplets from the printhead to the print medium is calculated. With the knowledge of this complete model, the print on the print medium can be realistically evaluated.

It is also possible for the trajectory module to calculate one portion of the trajectories and to evaluate another portion on the basis of the calculations. In particular it is possible for a neural network to handle the evaluation of the non-calculated trajectories. In further levels of development, it is possible for the calculation of the trajectories to be handled entirely by a neural network, it being possible for the results of the trajectory module optionally to constitute training data for the neural network.

It is particularly preferred for the transfer module to determine the transfer of the printing ink, in particular for each ink droplet, taking into account the position of the printhead and the print medium and optionally the “flight conditions”. The position is preferably determined for the printhead and for the print medium with respect to six independent coordinates each, such that the absolute positions thereof are known in the transfer module. The positions, in particular coordinates, are provided in particular by the path planning module. Similar computations apply if the positions provided to the transfer module are merely relative positions. It is also possible for certain simplification measures in the printing method to reduce the number of coordinates.

For example, the number can be reduced if the printhead or the print body is arranged so as to be stationary and in particular immobile. However, in the most general case, it is preferred for the six independent coordinates to be specified for both the printhead and the print medium for complete position determination.

In a preferred further development of the invention, the transfer module determines the transfer of the printing ink, in particular of each ink droplet, taking into account the speed of the printhead and the print medium. A distinction can be made between the absolute speeds and the relative speeds. The relative speeds are in particular important for being able to determine an impact point of the printing ink, in particular of each ink droplet, on the print medium. The absolute speed, in particular of the printhead, is necessary for being able to correct evaluate the transfer path, in particular the trajectory, specifically of each ink droplet. In the same way as for the positions, it is preferred for six independent coordinates for the speed to be provided for both the printhead and the print medium. The sets of coordinates for the speed can be specified by the path planning module as path planning data or can be simulated on the basis of stored machine performance parameters.

In a further development of the invention, the transfer module determines the transfer of the printing ink, in particular of each ink droplet, taking into account the acceleration of the printhead and the print medium. In this case too, the relative speeds between the printhead and the print medium can be taken into account in order to be able to correctly determine the impact point of the printing ink, in particular the ink droplet, on the print medium. However, it is also advantageous to take into account absolute acceleration, in particular of the printhead, in order to be able to correctly determine the influence of the acceleration state on the generation of droplets and thus the transfer path, in particular the trajectory, specifically of each ink droplet.

In a preferred further development of the invention, the simulation central module comprises a droplet auxiliary module for determining droplet parameters. The droplet auxiliary module is configured to transfer the droplet parameters to the trajectory module, with the trajectory module determining the at least one trajectory on the basis of the droplet parameters. As input parameters, the droplet auxiliary module can in particular use the printhead parameters and the ink parameters.

To simplify matters, punctiform operation based on measurement data can also be adopted, thereby simplifying the calculation of the collision points since calculations can be made using “punctiform” values.

Optionally in addition, it can be provided that the droplet auxiliary module implements a physical model of the printhead, with operating parameters of the printhead being used in addition. The physical model can, for example, take into account pressure fluctuations in the tank system, e.g., as a result of printhead movements or actions of multiple printheads attached to a shared tank system, and temperature influences acting on the ink temperature (e.g., due to temperature control/temperature control behavior in view of the pressure behavior, influences from external pressure sources, etc.).

In particular, the droplet auxiliary module calculates droplet size and/or droplet weight and/or kinetic sizes, such as droplet speed or droplet acceleration, etc. upon propulsion of the droplet from the printhead. These droplet parameters allow the trajectory module to calculate the trajectory of the ink droplet more accurately. Instead of the droplet auxiliary module, it can also be provided that standard parameters and/or constant parameters are evaluated and used as droplet parameters. Said parameters could be based on a rule set or empirical values, for example.

In a preferred further development of the invention, the simulation central module comprises an interaction module, with the interaction module taking into account the interaction between the 3D-surface portion and the printing ink and optionally additionally the curing devices and the parameters thereof. The interaction module can take into account the interaction between the printing ink, in particular the ink droplet, and the substrate with regard to wetting, running behavior on the surface, color mixing, coverage, etc. Moreover, the interaction module can take into account the interaction of multiple ink droplets that are located one above the other on the substrate and form an additive color mixture. By taking into account the curing devices and the parameters thereof, conclusions about the running of the printing ink, for example, can be taken into account in the interaction module. Alternatively, the curing devices and the parameters thereof can be taken into account in the transfer module. By the transfer module providing the impact point together with time information, the interaction module can also take into account time-specific effects in the interaction between the printing ink and the substrate. In particular, the times between the application of the printing ink of the individual droplets on the substrate and on the other droplets are taken into account. In particular, there can be differences in the running of the printing ink before becoming fixed as a result of the analysis, absorption of moisture by the object surface, etc.

Moreover, the interaction module can also take into account external influences, such as temperature for air drying/infrared drying in the case of water-based inks or UV curing in the case of UV-curable printing inks. In addition, further influence factors can be taken into account, such as curing with UV lamps or IR lamp or laser or surface pretreatment prior to printing (plasma, corona, laser, etc.), which also have an effect on the surface that diminishes or changes with time and depending on the environment.

Conceptually, the simulation device can be broken down into two main portions: In the first main portion, the position of the printing ink, in particular the ink droplet, on the print medium is determined. In the second main portion, in particular assisted by the interaction module, the color effect of the optionally multilayer printing ink on the print medium, in particular on the 3D surface portion, is determined. This makes it possible to simulate realistic coloring during printing.

In principle, it can be provided that the simulation device is operated for the printing pattern to be generated, in the sense that the printing pattern is used as input information for the transfer module. However, with regard to the simulation of certain or even all ink droplets, it is obvious that the computational effort is very high and could require several days, even with current, digital data processing devices. Thus, it is very time-consuming when a printing pattern is simulated as a print via the transfer module, the printing pattern is subsequently changed, and the entire print is resimulated. Therefore, it is possible for just a portion of the printing pattern to be simulated. This can be done before the printing pattern as a whole is simulated in order to optimize problem areas in isolation. Alternatively, after an initial simulation, a portion can be “resimulated” with changed parameters in order to locally optimize said portion.

In an alternative embodiment of the simulation device, the simulation central module comprises a printing pattern module. In this alternative, the transfer module determines the transfer of the printing ink onto the 3D-surface portion for a full printing pattern. A full printing pattern refers to a simulation in which each printhead prints over the entire surface. In this case, in the simulation, only overlapping color layers on the 3D surface portion are produced as the outcome, referred to below as a distribution pattern. The printing pattern module is configured to simulate the print on the basis of the distribution pattern of the full printing pattern and the printing pattern. In this case, it is possible for only critical regions to be fully calculated and for non-critical regions to be interpolated, for example. Alternatively or additionally, the resolution of the full printing pattern in first portions, in particular critical regions, is larger than in second portions, in particular non-critical regions, for example. Critical regions are understood in particular to be detailed and/or high-contrast regions and/or regions requiring a high level of printing quality. The full printing pattern can be defined, for example, by a “control element” taking into account a logic or “presimulation” in such a way that regions, in particular as critical regions in which a perfect distinction of the individual droplets is required, are simulated as a “full printing pattern”, and regions, in particular as non-critical regions that can be simplified, e.g., interpolated, the amount of data can be reduced and the full printing pattern is “thinned out” to optimize the simulation speed.

In this case, the distribution pattern is considered to represent a transfer function for the full printing pattern and thus for every possible ink droplet in the printing process. The printing pattern module is configured to use data from the distribution pattern relating to the droplets that are part of the printing pattern and to discard data relating to the other ink droplets. With this embodiment, it is possible to simulate changes in the printing pattern as changes in the print, with a relatively low computational effort, while maintaining the other parameters and data.

Preferably, the simulation device comprises an assessment central module for assessing the printing quality. For example, the assessment central module can assess different quality criteria, as follows:
uniformity of the print;
geometric distortion of the print;
positioning of the print;
fluctuations in resolution;
the ability to reproduce image sharpness on the surface;
the propulsion distance/flight time required for the transfer;
the impact speed;
impact angle to the normal of the surface;
overlapping of printing droplets/layer thickness;
time between two application steps, e.g., curing by a curing unit or application of further ink (time for the ink to run);
the influence of one or more simulated variances on parameters of the simulation input on the print image on the surface or the properties thereof, e.g., the error produced by a simulated control jitter of a movement axis, affecting the positioning of the droplets on the component, in particular represented as a vector field;
moiré effects;
assessment of subjective human perception;
antialiasing;
calibration to the eye;
etc.

It can be provided that the assessment central module outputs a visual quality assessment, such as a heat map, in order to be able to better understand the assessment results.

It is particularly preferred for the simulation device to comprise an optimization central module, with the optimization central module being configured, on the basis of the print, to improve, in particular optimize, the parameters and/or data, and to start a new full calculation via the transfer module. In this way, a control loop is implemented, which uses the parameters and/or data as a manipulated variable and printing quality or a target state as a target variable. For example, the printing quality can be optimized via the assessment central module to achieve a target state by input parameters, such as the print image or movement data, being modified in such a way that the target state is achieved.

It is also possible for only portions of the printing pattern to be resimulated in order to selectively optimize these portions.

In one alternative of the invention, the optimization central module is configured to improve only the printing pattern, specifically likewise, for example, also on the basis of the results of the assessment central module, with only a partial calculation being started by the printing pattern module. This alternative allows a much faster iteration of the optimization.

It is also possible to link the types of optimization with one another and to optimize the printing pattern via the printing pattern module in a first step and to then use the optimized printing pattern for a new full calculation.

In one possible further development of the invention, the optimization central module additionally has the function of influencing the simulation in the subsequent iteration. This is advantageous in that the balance between precision of the simulation and simulation time can be taken into account to suit the application. At least one, some or all of the following conditions can be used as manipulated variables for influencing the simulation:
Scope of the subsequent simulation: The optimization module can decide whether a simulation using the entire printing pattern with a complete new calculation, a simulation in portions with a complete new calculation, a new simulation using the entire printing pattern based on the full printing pattern, a new simulation in portions of the printing pattern on the basis of the full printing pattern, a mixture of the simulations, a new calculation of the full printing pattern and/or a new calculation in portions of the full printing pattern is to take place.

In a preferred implementation of the invention, the optimization central module is configured as a neural network, in particular as a deep neural network.

In one possible further development, it is provided that the printhead specification module, the object specification module, the ink specification module, the pattern specification module and the path planning module form a specification central module, with the specification central module, the simulation central module and optionally additionally the interaction module being configured as a neural network, in particular as a deep neural network, said neural network being trained with calculated data from the simulation device.

Preferably, all specifications for the modules in the specification central module can be configured as parameters, parameter fields, measurement curves, interpolated and/or extrapolated measurement curves or measurement fields, simulation parameters, etc. For each module in the specification central module, it is possible for the specifications thereof to be generated by a local neural network or to be at least partly generated or supplemented thereby. It can also be provided that the specification central module is configured entirely as a neural network.

In particular, the transfer module for calculating the transfer and/or the interaction module for determining the interaction can likewise be configured as neural networks.

In the mentioned neural networks, the simulation device can generate training data for the mentioned neural networks without neural networks or with neural networks in other functional regions.

The invention further relates to a method for simulating a print on a print medium and in particular for generating parameters for the print on the print medium, with the print being simulated by the simulation device as described above.

The invention further relates to a further simulation device for simulating printing a printing pattern on a print medium, the simulation device comprising a neural network configured to simulate the print. It is provided that the neural network is trained with training data from the simulation device according to any of the preceding claims or as described above. The invention further relates to a method for training said neural network. The further simulation device can be used in the same way as the above-described simulation device. In particular, the further simulation device is suitable and/or configured for evaluating and optionally optimizing the print on the 3D surface portion in order to implement a printing process which is in particular real and in which the print medium is printed on in the 3D surface portion by inkjet technology such that there is a print with printing ink on the 3D surface portion.

Further features, advantages and effects of the invention will be apparent from the following description of preferred exemplary embodiments of the invention, in which:

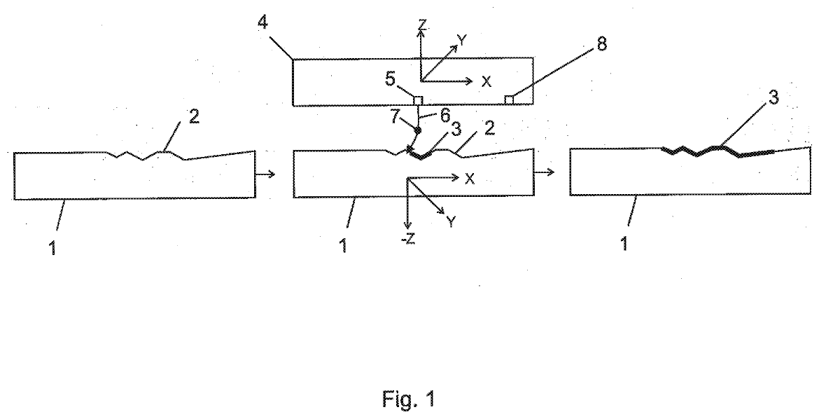

FIG. 1 shows a schematic sequence of a printing process for the simulation device;

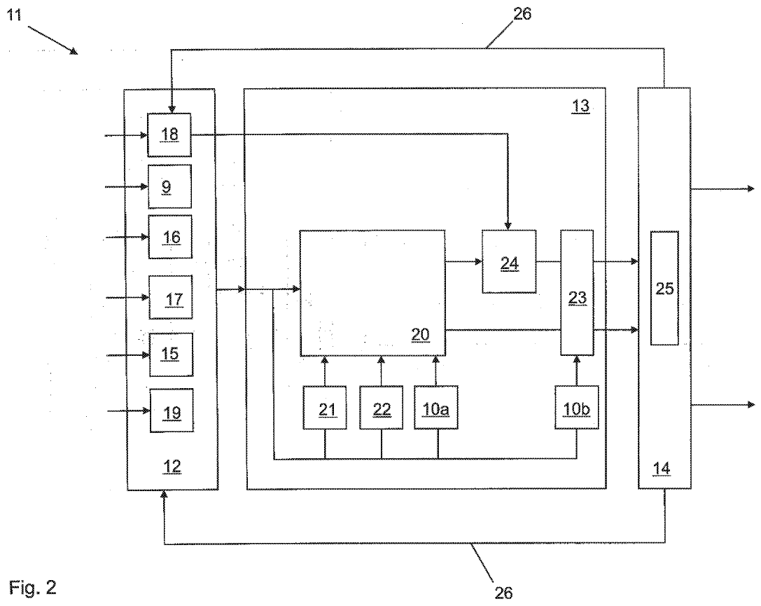

FIG. 2 shows a block diagram of a simulation device as one exemplary embodiment of the invention.

FIG. 1 is a highly schematized view of a printing process to be simulated. In the printing process, a print medium 1 is printed on in a 3D surface portion 2 by inkjet technology such that there is a print 3 with printing ink on the 3D-surface portion 2. The printing ink is transferred via one or more printheads 4, for example, from one or more nozzles 5 or rows or nozzles via a trajectory 6 onto the print medium 1 or the 3D surface portion 2 in the form of a droplet 7. Both the print medium 1 and the print medium 1 can each be arranged, moved and/or accelerated in up to six independent axes such that there is relative movement between the print medium 1 and the printhead 4. For example, these coordinates can be three Cartesian coordinates X, Y, X and rotational coordinates about the respective axes in order to fully describe the position, speed and acceleration using the six coordinates in each case. Optionally, one or more curing devices 8 are arranged, which are each configured as a UV lamp or IR lamp, for example. Using the curing device 8, the printing ink can be partially or fully cured. The curing device 8 can be arranged so as to be stationary. Alternatively, said curing device is movable and controllable such that the printing process can be varied on the basis of curing parameters, such as intensity, spacing, angle, wavelength, frequency, etc.

FIG. 2 shows a schematic block diagram of a simulation device 11 as one exemplary embodiment of the invention. On the basis of a print medium 1 and a printing pattern, the simulation device 11 has the function of simulating printing on a 3D surface portion 2 of the print medium. In the simulation, different parameters and data are taken into account. In a further embodiment, not only a simulation of the print takes place, but also an improvement and/or optimization, in particular of the data and parameters.

The simulation device is used in particular to simulate the print 3 in an additive surface coating method, in particular in an inkjet printing method. In particular, in the printing method, the printing ink is applied to the print medium 1 in the form of droplets.

The simulation device 11 comprises a specification central module 12, a simulation central module 13 and an optimization central module 14.

In the specification central module 12, different parameters and data are specified or set for the printing process. The specifications can be provided as characteristic maps and/or base data or can be defined by the specification modules as working points. In the simulation central module 13, the actual simulation of the print on the 3D surface portion takes place taking into account the parameters and data. In the optimization central module 14, an optimization of the parameters and data is initiated on the basis of the simulated print. Furthermore, an adjustment of the mode of operation of the simulation central module 13 can be implemented.

The specification central module 12 comprises a printhead specification module 15 for specifying printhead parameters. Geometric parameters of the printhead can be specified, such as a printing surface, the position and/or distribution and/or the diameter, etc. of printing nozzles. Moreover, dynamic parameters can be specified, such as the discharge speed of droplets 7 from the printhead. Furthermore, operating parameters can be specified, such as allowed processing distances between the printhead 4 and the print medium 1, etc. The printhead specification module 15 can also include parameter sets for different printheads of one type/design or different types/designs such that, as part of the optimization, a different printhead 4 is selected, or structural and/or functional properties of the selected printhead can be changed.

The specification central module 12 comprises an object specification module 16 which is configured to specify object parameters of the print medium. The object parameters can be in particular geometric parameters, such as the orientation and/or position and/or structure of the 3D surface portion 2. However, said parameters can also be object parameters with regard to the property for printing; in particular, properties of the surface and/or the color of the 3D surface portion can be indicated. Moreover, tolerances of the surface geometry, surface activity, temperature and other physical/chemical properties of the object or the object surface can also be specified.

The specification central module 12 comprises an ink specification module 17 for specifying ink parameters of the printing ink. The ink parameters can be physical and/or chemical properties of the printing ink, e.g., specific weight, moisture content, wetting behavior, temperature, curing properties, etc. In particular, the ink parameters also include parameters relating to color, coverage, mixability, etc. The printing ink is in particular a color printing ink but can alternatively also be a conductive coating, adhesive, etc.

The specification central module 12 comprises a pattern specification module 18 for specifying the printing pattern to be printed on the print medium, in particular on the 3D surface portion. The printing pattern can be configured as any desired pattern, such as an image, lettering, a structured functional coating, etc. Particularly preferably, the printing pattern is configured as a matrix, as known from image data, for example. For the application of 3D textures that produce, e.g., haptic effects, data formats typical of 3D printing can also be used.

The object parameters can be specified in particular as a CAD model and/or the printing pattern in UV coordinates. Alternatively, a CAD model having a printing pattern is specified, with the pattern specification module 18 and the object specification module 16 processing this input data together or being combined as a joint module.

The specification central module 12 optionally comprises a curing specification module 9, with the curing specification module 12 for specifying parameters with regard to the curing device 8. Moreover, parameters with regard to the intensity, position of the curing devices 8, etc. can be specified and optionally varied.

The specification central module 12 comprises a path planning module 19, with the path planning module being configured to specify path planning data for the print medium 1 and for the printhead. The path planning module 19 and the path planning data determine in particular the relative movement and/or the relative movement data and in particular the relative position and/or the relative speed and/or the relative acceleration between the print medium 1 and the printhead. In principle, all kinematic robot systems can be considered; thus, Cartesian systems, articulated arm systems or hybrid systems, etc. can be specified. It can be provided that the print medium 1 or the printhead 4 is arranged so as to be stationary or immobile, and only the other partner is moved. It can also be provided that both the print medium 1 and the printhead 4 are moved. The path planning module 19 can comprise an auxiliary module, with the auxiliary module implementing the assignment of printing regions to the printheads and/or printing nozzles. In particular, the auxiliary module comprises a raster image processor (RIP). Preferably, the auxiliary module processes the raw data and breaks it down into printing portions which, depending on the configuration of the printhead system, can be configured differently. Moreover, the path planning module 19 can access the specifications of the curing specification module 9 and take these specifications into account during path planning.

The specification central module 12 and in particular the specification modules 9, 15, 16, 17, 18, 19 can automatically specify the relevant parameters and data as part of optimization routines. However, said modules each comprise an input interface for adopting set parameters or data and/or initial values for the parameters or data. Thus, it is possible to operate the simulation device 11 as an open-loop control system or as a closed-loop control system.

The simulation central module 13 comprises a transfer module 20, with the transfer module 20 being configured to determine the transfer of the printing ink from the printhead 4 to the 3D surface portion 2. The transfer module 20 is configured, for example, as a trajectory module, with the trajectory module determining trajectories for each ink droplet that is discharged or propelled from the printhead 4 at a discharge point and strikes the print medium 1 at an impact point. To calculate or at least evaluate the impact point, the transfer module 20 uses parameters and data provided by the specification central module 12.

For example, the position, the speed and the acceleration of the printhead 4 or the print medium 1 are specified by the path planning module 19. Parameters of the printhead 4 and parameters of the print medium 1 are specified by the printhead specification module 15 and the object specification module 16 such that the time-specific positioning in relation to one another is known. Ink parameters of the printing ink are contributed from the ink specification module 17 such that the trajectories of the droplets 7 and in particular the discharge point and the impact point can be calculated.

In particular, the impact point is determined together with time information such that it is known when the droplet strikes the 3D surface portion 2.

Optionally, the simulation central module 13 comprises a droplet auxiliary module 21, with the droplet auxiliary module 21 being configured to determine droplet parameters. The droplet parameters are derived in particular from the printhead parameters, the ink parameters and optionally additionally the path planning data. For example, a physical model of the printhead can be stored in the droplet auxiliary module 21, with the physical model evaluating the droplet parameters, such as droplet size, droplet weight, propulsion speed, propulsion direction, etc. Said droplet parameters are delivered to the transfer module 20 in order to improve the determination of the trajectories.

Optionally, the simulation central module 13 comprises a system auxiliary module 22, with the system auxiliary module 22 being configured to adapt the path planning data to the real behavior of the system in the printing method. For example, it is known that systems often have tracking errors, acceleration errors, positioning errors, etc. Deviations from path planning data occur in particular in dynamic behavior. Deviations of this kind are known and can at least be evaluated in advance through similarly known methods or detected by measurement. The system auxiliary module 22 provides corrected path planning data as an output, which is used by the transfer module 20 instead of the path planning data from the path planning module 19.

Optionally, the simulation central module 13 comprises a first environment auxiliary module 10a, with the first environment auxiliary module 10a taking into account changed environmental parameters, in particular time-specific parameters, in the distribution of the droplets, such as increasing temperature when the system is in continuous operation, time of day, humidity, etc. Thus, the trajectories can be better calculated.

The simulation device 11 can be configured as three different alternatives:

### Alternative 1a:

In alternative 1a, the transfer module 20a receives, from the pattern specification module 18, the printing pattern that is to result in the print 3 on the print medium. On the basis of the printing pattern, the positioning of the individual droplets 7 on the print medium 1 is determined. Thus, for example, a stack, in particular an ordered stack, of ink droplets, in particular together with time information, is assigned to each point on the 3D surface portion 2. Alternatively or additionally, an impact point on the print medium 1 is assigned for each ink droplet. Both alternatives are then referred to as an ink droplet distribution.

### Alternative 1b:

In alternative 1b, only a portion of the printing pattern is simulated. In this way, it is possible to examine only a critical portion through simulation prior to a full simulation and to locally optimize this portion. Alternatively, the entire printing pattern can first be simulated, and the portion can then be locally optimized.

### Alternative 2:

In alternative 2, the transfer module 20 receives a full printing pattern, with the full printing pattern determining a maximum printing ink transfer. Thus, the printhead, in particular each printhead, is to transfer each printing ink over the entire surface. Alternatively or additionally, each printing nozzle 5 is to transfer every possible ink droplet. This results in an ink droplet distribution, with the ink droplet distribution taking into account every possible ink droplet. For every possible ink droplet, time information can be stored. In alternative 2, the simulation central module 13 comprises a printing pattern module 24, with the printing pattern module obtaining the ink droplet distribution of the full printing pattern and the printing pattern 24 from the pattern specification module 18. The printing pattern 24 is configured, in the ink droplet distribution of the full printing pattern, to keep the ink droplets that are required for the printing pattern and to discard the ink droplets that are not required for the printing pattern. The output is then the ink droplet distribution for the printing pattern.

The alternatives are described together in more detail below:

Downstream of the transfer module 20 or the printing pattern module 24 in the data pathway, there is an interaction module 23 which likewise forms a component in the simulation central module 13. The interaction module 23 calculates the interaction between the 3D surface portion 2 and the ink droplets in accordance with the ink droplet distribution. In the process, in particular ink parameters of the printing ink are taken into account, said ink parameters describing coverage, mixability, curing, surface tension and object parameters of the 3D surface portion that describe a base color, a base material for calculating a possible distribution or enlargement of the ink droplets upon impact, etc. The calculation is performed in particular with respect to time such that the particular curing state, drying state of the ink droplet in relation to the substrate and to the other ink droplets can be taken into account. The interaction module 23 calculates or determines the print 3 on the 3D surface portion 2 of the print medium.

Optionally, the simulation central module 13 comprises a second environment auxiliary module 10b, with the second environment auxiliary module 10b taking into account changed environment parameters, in particular time-specific parameters for the run properties and/or the curing of the printing ink, such as increasing temperature when the system is in continuous operation, time of day, humidity, etc. Alternatively or additionally, the second environment auxiliary module 10b accesses the specifications from the curing specification module 9 such that the interaction module 23 can model the interaction of the ink droplets with one another and with the object to be printed on.

For example, it is possible to output a model of the print medium together with the print 3 and to view and assess said model in a typical visualization program, in particular a 3D visualization program. For colored inks, a texture can be added to the model such that, in addition to the geometric display, a color display of the surface properties can be visualized according to the print simulation.

Alternatively or additionally, the simulation device 11 comprises an assessment module 25 in the optimization central module 14, with the assessment module 25 being configured to assess the print 3 on the print medium. Possible quality criteria have already been mentioned in the description of the invention, inter alia:
uniformity of the print;
geometric distortion of the print;
positioning of the print;
etc.

Optionally, it can be provided that the assessment module 25 can access a target state of the print and carry out the assessment in a comparison with the target state.

The results of the assessment can be outputted as numerical values, such as school grades. Alternatively, it is possible to output a graphical assessment, with the 3D surface portion 2 being covered in a coded map, such as a heat map, in which regions with a poor assessment are coded with colors, in particular signal colors.

For example, it is possible to output the assessment and in particular to manually evaluate said assessment in conjunction with the model of the print medium together with the print 3 in order to change the parameters and data in the specification central module 12.

Alternatively or additionally, it is possible for the optimization central module 14 to carry out an optimization of the parameters and optionally data in the specification central module 12 and to feed these changed parameters and optionally this changed data back to the specification central module 12 via a feedback branch 26.

In relation to the above-mentioned alternatives, it is possible, in alternative 1, to change only the printing pattern as feedback. The changed printing pattern can then be immediately fed back to the printing pattern module 24 such that, with little computational effort, there is a print 3 on the print medium on the basis of the changed printing pattern, it being possible for said print to be outputted again or to be reassessed in the assessment module 25 and optionally to be changed again by the optimization central module 14. In this case, only a partial calculation is carried out since the ink droplet distribution of the full printing pattern does not have to be recalculated.

In alternative 2, however, the printing pattern is recalculated by the transfer module 20, meaning that a full calculation of the simulation has to be carried out. In both kinds of optimization, it is also possible for only portions to be optimized.

It is possible for the optimization central module 14 to also adjust the mode of operation of the simulation device 11 and to make a selection regarding the type of remodeling (complete/only portions; full printing pattern/full calculation).

During operation, it is possible for the printing pattern to be first improved as far as possible through alternative 1 and for further parameters to be then improved through alternative 2.

In a further development of the simulation device 11, the optimization central module 14 can be configured as a neural network. The assessment module 25 can be part of the neural network but can also be provided upstream of the neural network.

### LIST OF REFERENCE NUMERALS

1 print medium
2 3D-surface portion
3 print
4 printhead
5 printing nozzles
6 trajectory
7 ink droplet
8 curing device
9 curing specification module
10a first environment auxiliary module
10b second environment auxiliary module
11 simulation device
12 specification central module
13 simulation central module
14 optimization central module
15 printhead specification module
16 object specification module
17 ink specification module
18 pattern specification module
19 path planning module
20 transfer module
21 droplet auxiliary module
22 system auxiliary module
23 interaction module
24 printing pattern module
25 assessment module
26 feedback branch

1-15. (canceled)

16. A simulation device for simulating the printing of a printing pattern on a print medium, the print medium comprising at least one 3D surface portion to be printed on, and for evaluating and optionally optimizing the print on the 3D surface portion in order to implement a printing process in which the print medium is printed on in the 3D surface region by inkjet technology such that there is a print with printing ink on the 3D surface portion, the simulation device comprising: a printhead specification module for specifying printhead parameters; an object specification module for specifying object parameters of the print medium; an ink specification module for specifying ink parameters of the printing ink; a pattern specification module for specifying the printing pattern; a path planning module for specifying path planning data for the print medium and for a printhead; and a simulation central module for simulating the print on the 3D surface portion taking into account the printhead parameters, object parameters, ink parameters, path planning data and the printing pattern.

17. The simulation device according to claim 16, wherein the simulation central module comprises a transfer module for determining a transfer of the printing ink onto the 3D surface portion.

18. The simulation device according to claim 17, wherein the transfer module is configured as a trajectory module, wherein the trajectory module determines at least one trajectory, certain trajectories or all trajectories for the printing ink leaving the printhead and striking the 3D surface portion.

19. The simulation device according to claim 18, wherein the trajectory module determines the at least one trajectory for each ink droplet.

20. The simulation device according to claim 17, wherein the transfer module determines the transfer of the printing ink taking into account the positions of the printhead and the print medium.

21. The simulation device according to claim 17, wherein the transfer module determines the transfer of the printing ink taking into account speeds of the printhead and the print medium.

22. The simulation device according to claim 21, wherein the transfer module determines the transfer of the printing ink taking into account the relative speed of the printhead and the print medium.

23. The simulation device according to claim 17, wherein the transfer module determines the transfer of the printing ink taking into account accelerations of the printhead and the print medium.

24. The simulation device according to claim 18, wherein the simulation central module comprises a droplet auxiliary module for determining droplet parameters, wherein the droplet auxiliary module is configured to give the droplet parameters to the trajectory module, wherein the trajectory module is configured to determine the at least one trajectory based on the droplet parameters.

25. The simulation device according to claim 24, wherein the droplet parameters relate to a size and/or weight of an ink droplet and/or a kinetic parameter of the ink droplet.

26. The simulation device according to claim 16, wherein the simulation central module comprises an interaction module, wherein the interaction module is configured to take into account an interaction between the 3D surface portion and the printing ink.

27. The simulation device according to claim 17, wherein the simulation central module comprises a printing pattern module, wherein the transfer module determines a transfer of the printing ink onto the 3D surface portion for a full printing pattern, the printing pattern module being configured to simulate the print based on the full printing pattern and the printing pattern.

28. The simulation device according to claim 27, further comprising an optimization central module, wherein the optimization central module is configured, based on the simulated print, to optimize parameters and optionally data and to start a new full calculation via the transfer module and/or to optimize the printing pattern and to start a partial calculation via the printing pattern module.

29. The simulation device according to claim 28, wherein the optimization central module and/or an assessment module is configured as a neural network.

30. A simulation method for simulating a print on a print medium and for generating parameters for the print on the print medium, the method comprising the step of simulating using a simulation device according to claim 16.

31. The simulation device according to claim 16, further comprising a neural network configured to simulate the print, wherein the neural network is trained with training data from the modules.
